(19) United States
(12) Patent Application Publication
(10) Pub. No.: US 2002/0177440 A1
(43) Pub. Date: Nov. 28, 2002

(54) System and method for providing serviceto guest users in a wireless enterprise network

(76) Inventor: Subrata Mukherjee, Plano, TX (US)

Correspondence Address: Navarro IP Law Group, Suite 655, 801 E. Campbell Rd., Richardson, TX, 75081, US

(21) Appl. No.: 09/864,791

(22) Filed: May 24, 2001

(51) Int. Cl. H04Q 7/20

(52) U.S. Cl. 455/433; 455/432; 455/414

(57) ABSTRACT

The invention presents methods and system for providing service to a guest user (24) within a wireless enterprise network (20). A location update request is received from a guest user (24) within a service area of the enterprise network (20). A guest number is allocated to the guest user (24) and the guest user (24) is registered and provided services in the enterprise network (20) as if the enterprise network (20) were a Mobile Switching Center (MSC) of the Public Land Mobile Network (PLMN) (22) of the guest user (24). The system includes a PLMN (22) supporting wireless service for a plurality of wireless terminals. The PLMN (22) includes at least one Mobile Switching Center (MSC) for registration of wireless users.

### TECHNICAL FIELD

This invention relates in general to providing wireless services in an enterprise communication network and, in particular, to methods and systems for providing wireless services to guest users in a wireless enterprise network. More particularly, the invention relates to methods and systems for allowing guest wireless users to participate in an enterprise network as though the guest users were enterprise users.

### BACKGROUND OF THE INVENTION

PLMNs are commonly employed to provide wireless voice and data communications to authorized users using individual wireless terminals. For example, PLMNs using Code Division Multiple Access (CDMA) and Time Division Multiple Access (TDMA), as well as other communication protocols, have been introduced, providing voice services to their users using TDMA or CDMA wireless terminals. Global System for Mobile communications (GSM) is one example of a TDMA system in widespread use.

Additionally, enterprise networks are commonly employed to provide voice and data communications to authorized subscribers within an enterprise area such as a building, campus, or office suite. An example of such an enterprise network's “GSM on the Net,” available from Ericsson, Inc. “GSM on the Net” is Internet Protocol (IP) based, using the H.323 standard. Other IP protocol-based enterprise networks are also available.

As both PLMNs and enterprise networks are deployed around the world, some network operators find it desirable to provide services to PLMN users within an enterprise network environment. This situation may arise, for example, when there is no PLMN coverage for a particular enterprise area, or where it is desired to offer supplemental service directed to mobile users within the enterprise area. One approach is the “GSM on the Net” product line offered by Ericsson, Inc. With “GSM on the Net,” access to an enterprise network is achieved by emulating a Mobile Switching Center (MSC) for preauthorized terminals. This approach necessitates that the individual GSM users be previously registered as authorized users of the enterprise network. A major shortcoming of such systems is the inherent inability to provide unregistered or “guest” wireless users with enterprise network services.

One approach to solving this problem is described in U.S. patent application Ser. No. 09/821,479 assigned to Ericsson, Inc., and incorporated herein for all purposes by reference. In the prior application, the enterprise network is configured to provide an MSC interface to the registered enterprise users and is also configured to appear as a Base Station Controller (BSC) to unregistered wireless terminals. This effort to provide enterprise network services to guest users is complex and expensive to implement due to the requirement for two different types of interfaces.

Accordingly, improved means of providing guest users with service in enterprise networks would provide numerous advantages including a reduction in cost and complexity. The ability to dynamically authorize guest users for participation in the enterprise network would also provide numerous advantages in improving services.

### SUMMARY OF THE INVENTION

The invention includes methods and systems for providing enterprise network service to users within an enterprise network service area. The invention provides the capability for allocating enterprise network access to guest users, allowing the enterprise network to deliver services not only to enterprise users, but also to guests using standard mobile terminals on an ad hoc basis.

Disclosed is a method for providing service to a guest wireless user within a wireless enterprise network in addition to providing service to registered users of the enterprise network. The method includes the step of receiving a location update request from a guest user within a service area of the enterprise network. Next, a guest number is allocated to the guest user and the guest user is registered for service in the enterprise network according to PLMN mobility management procedures, thereby enabling the enterprise network to provide wireless service to the guest user.

Also disclosed is a method of providing service to a guest user within a wireless telecommunication enterprise network wherein the enterprise network emulates a Mobile Switching Center (MSC) in a General System for Mobile communications (GSM) Public Land Mobile Network (PLMN). The enterprise network maintains a pool of guest numbers for allocation to guest users upon receipt of location update requests from guest users. The guest user is registered for service in the enterprise network such that wireless service is provided to the guest user within the service area of the enterprise network.

Also disclosed is a system for providing wireless terminal service for users in an enterprise network environment. The enterprise network environment includes a Public Land Mobile Network (PLMN) supporting wireless service for a plurality of wireless users. The PLMN includes at least one Mobile Switching Center (MSC) for registration of wireless users. The enterprise network supports service for a plurality of enterprise users within a service area of the enterprise network. The enterprise network further includes means for allocating a guest number to a wireless user native to the PLMN and guest to the enterprise network, whereby the guest user may be provided enterprise network services within the service area of the enterprise network.

Technical advantages realized by the invention are numerous and include the ability to provide guest users with services in an enterprise network with less complexity and cost than known systems or methods. A further advantage of the invention is that guest users are treated as temporary enterprise network users when roaming the enterprise service area. Service advantages accrue to both guest users and the enterprise network due to the ability to dynamically provide access to network enterprise resources with improved efficiency and service options.

### BRIEF DESCRIPTION OF THE DRAWINGS

The above advantages, as well as specific embodiments of the present invention, will be more clearly understood from consideration of the following description in connection with accompanying drawings in which:

FIG. 1 is a block diagram showing an example of the systems and methods of the invention in use with an enterprise network;

FIG. 2 is a process flow diagram showing the steps identified in the example of FIG. 1;

FIG. 3 is a block diagram showing an example of call set-up using the invention of FIGS. 1 and 2;

FIG. 4 is a process flow diagram showing the steps corresponding to the example of FIG. 3;

FIG. 5 is a block diagram showing an example of de-registration of a guest user with the invention of FIGS. 1-4;

FIG. 6 is a process flow diagram representing the steps of the example of FIG. 5; and

FIG. 7 is a process flow diagram summarizing the progression of steps during call setup towards a registered guest user with the invention of FIGS. 1-6.

Corresponding numerals and symbols in the various figures refer to corresponding parts unless otherwise indicated.

### DETAILED DESCRIPTION OF PREFERRED EMBODIMENTS

While the making and using of various embodiments of the present invention are discussed in detail below, it should be appreciated that the present invention provides many applicable inventive concepts which can be embodied in a wide variety of specific contexts. It should be understood that the invention may be practiced with enterprise networks and PLMNs of various types, sizes and locations. Some features of embodiments shown and discussed are simplified or exaggerated for illustrating the principles of the invention.

The systems and methods of the invention can be understood with reference to FIG. 1 in which an enterprise network 20 is shown. An example of an enterprise network 20 with which the invention may advantageously be used is “GSM on the Net” available from Ericsson, Inc. Of course, other enterprise networking systems may be used provided that they include wireless terminal users and service. The “GSM on the Net” system shown in this example is based on ITU-T recommendation H.323 which describes terminals, equipment and services for multimedia communication over a packet-based network. The enterprise network 20 can be accessed in a variety of ways, for example, by means of IP phones, Personal Computers (PCs), and GSM phones. GSM terminals registered with the enterprise network 20, for example, would be recognized as authorized users by the enterprise network 20 during a location update or when requesting service within the enterprise network service area.

Typically, the enterprise network 20 environment exists in conjunction with an overlying PLMN 22. Although the PLMN 22 is described in context of a Global System for Mobile communication systems, the invention may be practiced with other PLMN topologies such as, for example, wireless networks using Code Division Multiple Access (CDMA), Enhanced Data for GSM Evolution (EDGE), and Digital Advanced Mobile Phone Service (DAMPS). The term “guest user” 24 is used for the purpose of discussing how a particular PLMN user may interact with the enterprise network 20. It should be understood that the guest user 24 is a user native to the PLMN 22, but not preregistered with the enterprise network 20. Of course, in practice, many guest users 24 may exist simultaneously. In the following example, the registration sequence encountered by a guest user 24 using the systems and methods of the invention is shown and described.

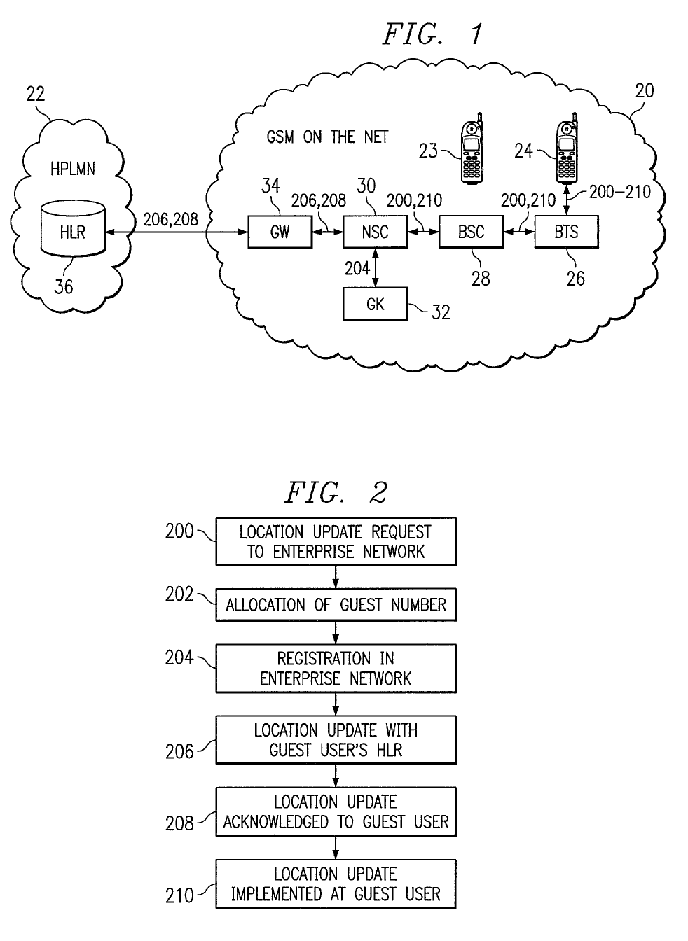

Now referring to FIGS. 1 and 2, when a guest user 24 moves into the enterprise network 20 service area, the guest user 24 attempts to perform a location update in accordance with the mobility management procedures of its home PLMN 22. A base transceiver station (BTS) 26 of the enterprise network 20 receives a location update request (step 200). The location update request is relayed to a Base Station Controller (BSC) 28 and, in turn, to a Mobile Switching Center (MSC) 30 of the enterprise network 20. When the MSC 30 receives the location update request, it is determined that the guest user 24 is not a valid enterprise user 23 preregistered with the enterprise network. That is, the International Mobile Subscriber Identity (IMSI) received in the location update request is not defined in the database for IMSls of valid enterprise users, e.g., 23.

The MSC 30 then allocates (step 202) a guest number to the guest user 24 and registers (step 204) the guest user 24 with the Gate Keeper (GK) 32 of the enterprise network 20.

It should be understood that an association is made between the selected guest number and the IMSI/MSISDN (Mobile Station Integrated Services Digital Network) number of the guest user 24 within the enterprise network 20. Thereafter, registration with the home PLMN 22 of the guest user 24 is performed, in emulation of procedures known in the arts for a PLMN user registering as a visitor with an MSC. Specifically, the gateway 34 of the enterprise network 20 updates (step 206) the Home Location Register (HLR) 36 of the PLMN 22 with the location of the guest user 24. The HLR 36 acknowledges (step 208) the location update to the signaling gateway 34. A location update acceptance message is sent (step 210) to the guest user 24, and services to the guest user 24 are accordingly made accessible by the MSC 30 of the enterprise network 20.

To summarize, the process flow diagram of FIG. 2 shows the logical flow of the registration sequence of FIG. 1. In step 200, a location update request is sent by the guest user, in this case, with a GSM terminal. In step 202, the MSC allocates a guest number associated with the IMSI, preferably from a pool of available guest numbers. At step 204, the registration of the guest number within the enterprise network takes place, in this example using H.323 IP protocol for network communications. In step 206, a location update message is transmitted to the signaling gateway of the enterprise network and, in turn, to the HLR of the PLMN. In step 208, the location update is acknowledged by the HLR of the PLMN to the signaling gateway. And in step 210, a location update accept message, known in GSM, is transmitted to the guest user, acknowledging that the guest user is now capable of using the services of the enterprise network.

The invention provides a simplified mechanism of providing service to guest users of the enterprise network. This is accomplished, in part, by providing an MSC interface to both the PLMN and elements of the enterprise network. Thus, a user of the PLMN 22 entering the enterprise network 20 is serviced as if roaming from one MSC of the PLMN 22 to another MSC (of the enterprise network).

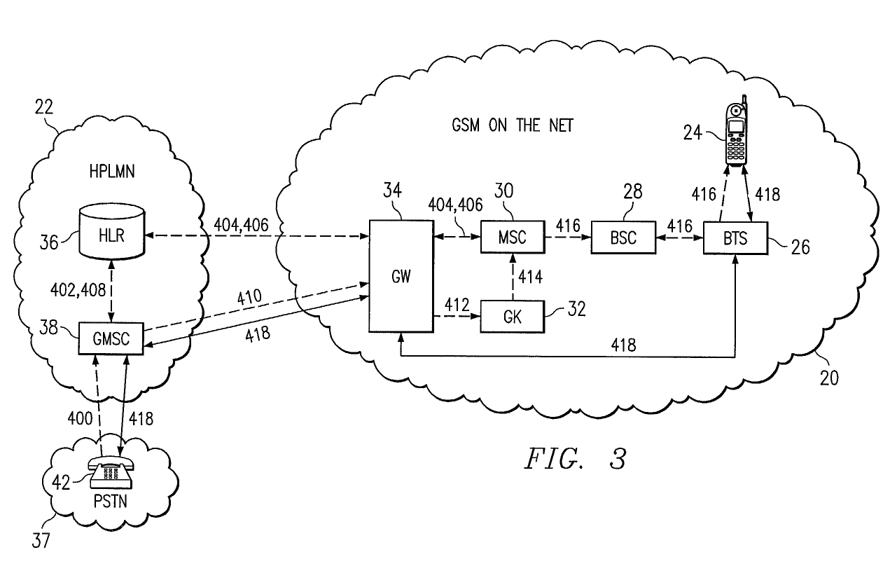

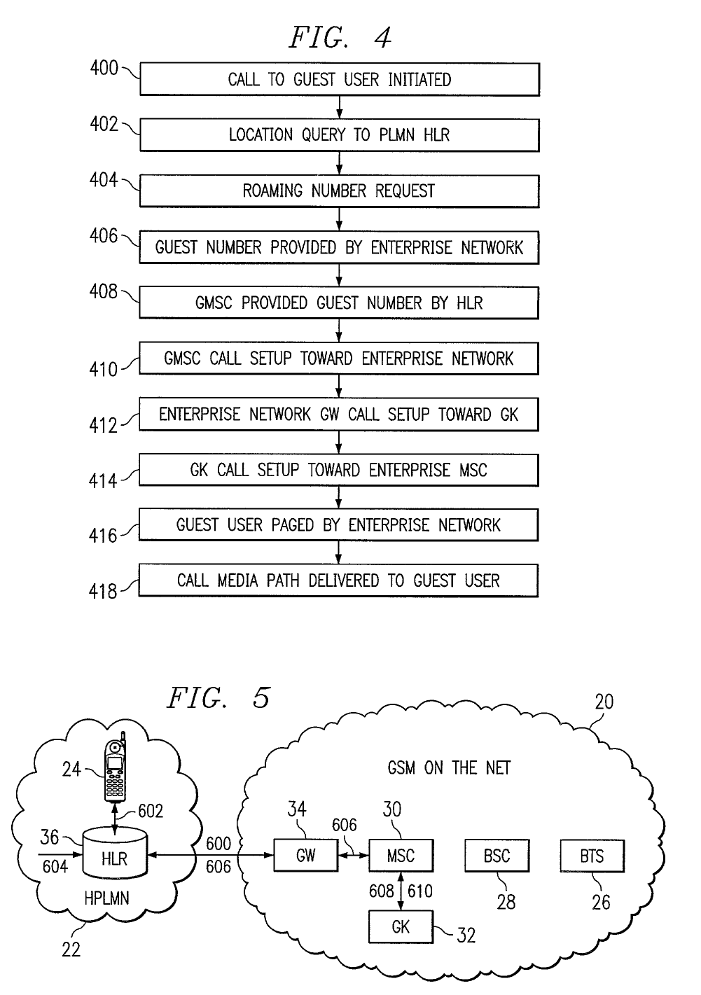

FIG. 3 shows an example of call setup toward a guest user 24 previously registered with the enterprise network 20, according to the discussion of the example of FIGS. 1 and 2. It should be understood that once a user is registered with the enterprise network 20 as a guest user 24, the enterprise network 20 treats the guest user 24 the same way it treats a wireless user 23 of the enterprise network 20, preferably the guest's user profile in the PLMN HLR 36 may be used to determine the extent of services the guest user 24 subscribes to in the PLMN 22. Such services may be matched or supplemented by the enterprise network 20 operator. FIG. 4 is a process flow diagram corresponding to the steps (400-418) enumerated in the following description of FIG. 3.

With continued reference to FIGS. 3 and 4, assuming that a call is initiated from the public switched telephone network 37 by dialing the MSISDN of the registered guest user 24, the call would proceed as follows. Since the Point Of Presence (POP) for MSISDNs of GSM mobile terminals (e.g., 24) is the gateway MSC (GMSC) 38 of the PLMN 22, the call setup attempt comes first from the PSTN 37 to the GMSC 38 (step 400). The GMSC 38 does a location query toward the HLR 36 in step 402. The HLR 36, in step 404, requests a roaming number from the MSC 30, which emulates an MSC of the PLMN 22. The message is received by the MSC 30 through a Gateway (GW) 34, for example, via SS7. In step 406, the MSC 30 returns the guest number (allocated in FIGS. 1 and 2) toward the PLMN 22 of the guest user 24. The guest number is received in the HLR 36 through the gateway 34.

As shown in step 408, the GMSC 38 receives the guest number, equivalent to the roaming number in the PLMN 22, from the HLR 36. The GMSC 38, in step 410, does an SS7 call setup toward the GW 34 of the enterprise network 20. The GW 34 does an H.323 call setup toward the Gate Keeper (GK) 32 in step 412. The GK 32, in turn, does an H.323 call setup toward the MSC 30 (in step 414) since it is able to determine that the guest user 24 is registered with the enterprise network 20, and the MSC 30 controls calls to the guest number. In step 416, the MSC 30 does a GSM call setup, including paging, toward the guest user 24.

It should be understood by those skilled in the arts that the call setup follows the path from the guest user 24-BTS 26-BSC 28-MSC 30-GK 32 GW 34-GMSC 38-calling party terminal 42. As shown in step 418, the media, in this case voice, is carried from the calling party terminal 42 via the GMSC 38, the GW 34, and the BTS 26, to the guest user 24. The essentials of the invention should be clear to persons skilled in the arts. Of course, the specifics of the example could be changed to show a call from the guest user, or guest terminal use of messaging or other services without altering the essential characteristics of the invention.

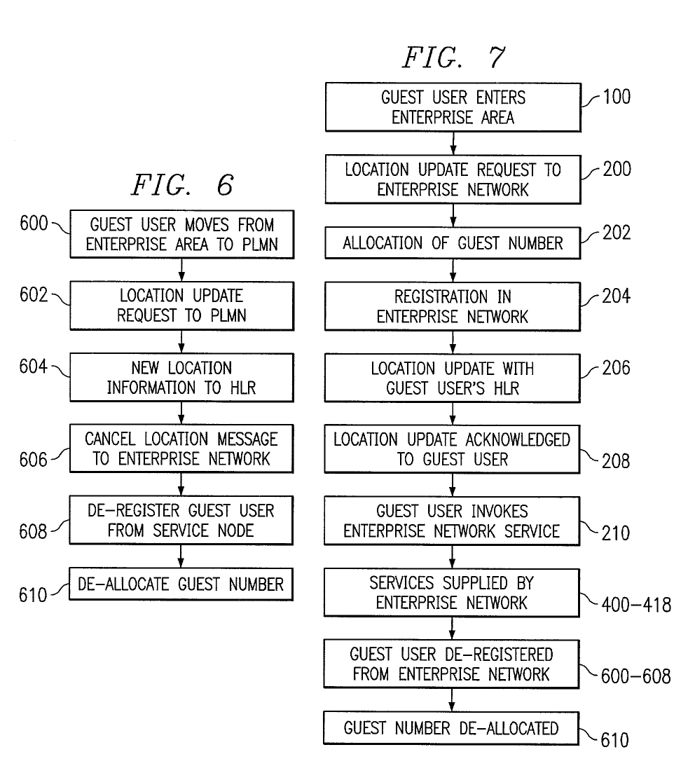

It should be understood that at some point, a guest user (e.g., 24) may leave the enterprise network service area 20, may be turned off, or otherwise become unavailable within the enterprise network 20. FIGS. 5 and 6 represent an example of the de-registration of a guest user 24 and the de-allocation of a guest number, which is returned to the guest number pool of the enterprise network 20. Typically, a guest user 24 moves from the enterprise network service area 20 to the PLMN service area 22 (step 600), or otherwise becomes unavailable. The returning PLMN user 24 then does a location update, step 602, toward the PLMN 22.

In step 604, the new location information is processed by the PLMN HLR 36. The HLR 36 previously had recorded the enterprise network 20 as the location for the mobile user 24 and, therefore sends a cancel location message toward the MSC 30, in step 606. The MSC 30 de-registers the mobile user 24 from the GK 32, at step 608 and accordingly, de-allocates the guest number and returns it to the pool of available guest numbers (step 610). It should be understood that there are other ways a guest user could become de-registered and the guest number could be de-allocated. For example, if a guest user registered with the enterprise network 20 has not made any radio contact with the network 20 for a predetermined length of time, he/she may be de-registered by the GK 32.

FIG. 7 shows a process flow diagram summarizing the guest user registration, service, and de-registration described in the previous examples of FIGS. 1-6. At step 100, a guest user enters the enterprise network service area. At step 200, a location update request is transmitted to the enterprise network. Accordingly, in step 202, a guest number is allocated by the enterprise network and in step 204, registration in the enterprise network is completed for the guest user.

In step 206, the enterprise network performs a location update with the guest user's HLR in emulation of an MSC of the guest user's PLMN. The PLMN acknowledges the location update, and the enterprise network, in turn, acknowledges the location update to the guest user in step 208, signifying that the enterprise network is prepared to provide service. A guest user may invoke enterprise network service, as shown in step 210, and services supplied by the enterprise network, steps 400-418, may include services tailored to the user profile supplied by the PLMN HLR or may be limited to services chosen for provision to guest users by the enterprise network operator. In the event the guest user leaves, powers down, or otherwise is deemed not to require services, the guest user is de-registered from the enterprise network in steps 600-608. Upon de-registration of a guest user, the guest number is de-allocated, in step 610. The guest number is returned to a pool of available guest numbers for serving additional potential guest users. Of course, the specifics of the example could be changed to show a call from the guest user, or guest user utilization of messaging or other services without altering the essential characteristics of the invention.

The embodiments shown and described above are only exemplary. Even though numerous characteristics and advantages of the present invention have been set forth in the foregoing description together with details of the method of the invention, the disclosure is illustrative only and changes may be made within the principles of the invention to the full extent indicated by the broad general meaning of the terms used in the attached claims.

I claim:

1. A method of providing service to a guest user within a wireless enterprise network, comprising the steps of:
receiving a location update request from a guest user within a service area of the enterprise network;
allocating a guest number to the guest user;
registering the guest user for service in the enterprise network; and
the enterprise network providing wireless service to the guest user.

2. The method of claim 1 further comprising the step of the enterprise network emulating a Mobile Switching Center (MSC) in a Public Land Mobile Network (PLMN).

3. The method of claim 2 further comprising the step of registering the guest user with a Home Location Register (HLR) of a PLMN.

4. The method of claim 3 further comprising the step of the enterprise network authenticating the guest user with an HLR, for service by the enterprise network.

5. The method of claim 4 further comprising the step of the enterprise network emulating a Mobile Switching Center (MSC) with respect to the guest user.

6. The method of claim 2 further comprising the step of the enterprise network treating the guest user as if roaming from the enterprise network to an MSC of the PLMN.

7. The method of claim 1 further comprising the step of the enterprise network de-registering the guest user.

8. The method of claim 1 further comprising the step of the enterprise network maintaining a pool of guest numbers.

9. The method of claim 1 further comprising the step of the enterprise network de-allocating the guest number by returning it to a pool of guest numbers.

10. The method of claim 1 further comprising the step of the enterprise network using H.323 signaling for communication among elements of the enterprise network.

11. The method of claim 1 further comprising the step of the enterprise network providing wireless service to an enterprise user.

12. A method of providing service to a guest user within a wireless telecommunication enterprise network, comprising the steps of:
emulating a Mobile Switching Center (MSC) in a Public Land Mobile Network (PLMN);
maintaining a pool of guest numbers;
receiving a location update request from a guest user;
allocating a guest number to the guest user;
registering the guest user for service in the enterprise network; and
the wireless telecommunication enterprise network providing wireless service to the guest user.

13. The method of claim 12 further comprising the step of registering the guest user with a Home Location Register (HLR) of a PLMN.

14. The method of claim 13 further comprising the step of the enterprise network authenticating the guest user with an HLR, for service by the enterprise network.

15. The method of claim 14 further comprising the step of the enterprise network treating the guest user as if roaming from the enterprise network to an MSC of the PLMN.

16. The method of claim 12 further comprising the step of the enterprise network de-registering the guest user.

17. The method of claim 1 further comprising the step of the enterprise network de-allocating the guest number by returning it to a pool of guest numbers.

18. The method of claim 1 further comprising the step of the enterprise network using H.323 signaling for communication among elements of the enterprise network.

19. The method of claim 1 further comprising the step of the enterprise network providing wireless service to an enterprise user.

20. A system for providing wireless terminal service in an enterprise network environment comprising:
a Public Land Mobile Network (PLMN) supporting wireless service for a plurality of wireless terminals, the PLMN including at least one Mobile Switching Center (MSC) for registration of wireless terminals;
an enterprise network supporting service for a plurality of enterprise terminals within a service area of the enterprise network, the enterprise network including means for supporting access by a wireless terminal to services of the enterprise network; and
a wireless terminal native to the PLMN and guest to the enterprise network;
wherein the enterprise network further comprises means for allocating a guest number to the wireless terminal for use by the wireless terminal within the service area of the enterprise network.

21. The system of claim 20 further comprising means for registering the guest terminal with a Home Location Register (HLR) of the PLMN.

22. The system of claim 21 further comprising means for authenticating the guest terminal with an HLR, for service by the enterprise network.

23. The system of claim 20 wherein the enterprise network further comprises an H.323 network.

24. The system of claim 20 wherein the PLMN further comprises a Global System for Mobile communications (GSM) network.
